(19) United States
(12) Patent Application Publication
(10) Pub. No.: US 2021/0285795 A1
(43) Pub. Date: Sep. 16, 2021

(54) USING FLUX GUIDES FOR IMPROVED ROTATIONAL MEASUREMENTS

(71) Applicant: AZOTEQ (PTY) LTD, Paarl (ZA)

(72) Inventors: Frederick Johannes BRUWER, Paarl (ZA); Douw Gerbrandt VAN DER MERWE, Paarl (ZA); Daniel Barend RADEMEYER, Paarl (ZA); Landolf Christoph THERON, Paarl (ZA)

(21) Appl. No.: 17/197,418

(22) Filed: Mar. 10, 2021

(30) Foreign Application Priority Data
Mar. 10, 2020 (ZA) 2020/01494

(51) Int. Cl. G01D 5/14; G01B 7/30

(52) U.S. Cl. CPC G01D 5/145; G01B 7/30

(57) ABSTRACT

The present invention teaches the use of a plurality of high magnetic permeability material flux-guides to improve the amount of phase shift between signals generated by distinct magnetic field sensors, allowing improved rotation sensing of a rotating magnet. The plurality of flux-guides is at least equal in number to the number of distinct magnetic field sensors. In a preferred implementation, Hall plates in an integrated circuit are used as magnetic field sensors.

### CROSS-REFERENCE TO RELATED APPLICATION

The present application claims priority from South Africa application ZA 2020/01494, filed on Mar. 10, 2020, the contents of which is hereby incorporated by reference into this application.

### BACKGROUND OF THE INVENTION

In most products and especially in consumer products cost is a very important metric to keep under control. Often a new technology with better performance cannot break into a market if the cost is higher than an existing implementation. A good example is the rotational measurement of the wheel in a computer mouse. The most prevalent implementation is either electro-mechanical contacts with, for example, 26 points over the 360 degrees or optical encoders with approximately double said number (26) of measurement points. The electro-mechanical system is lower in cost but gives bigger quantization than the optical system. The optical system is more accurate, more expensive and has some manufacturing accuracy requirements. However, due to the low cost, both systems are very much the de facto solution circa 2020.

Hall sensors and rotational measurements of magnets using Hall sensors or other magnetic field sensors/detectors are well known in the art and can give very accurate angular measurement results. However, factors such as high power consumption and the resolution that can be attained with Hall plates on a single IC have created some hurdles against the adoption thereof in very high volume applications. A specific challenge is to realize a sufficiently large phase angle between the signals from two Hall plates, which may improve the accuracy and ease of rotation sensing.

A bigger phase angle can be attained by using multiple discrete IC's but using more than one IC does increase the cost which is problematic. The solutions presented in this specification effectively overcome such problems to allow for very low cost Hall sensing solutions for rotational measurements.

U.S. Pat. No. 7,188,533 teaches the possibility to adjust the phase angle between signals of two Hall plates by moving two discrete devices which houses said plates, apart. In this case the intention is to obtain an in-phase relation. This is opposite to the requirement during rotation sensing, where one typically wants to increase the phase angle.

Magnetic flux-guides or flux-conductors may be used to guide magnetic fields along a specific path or to focus magnetic fields onto a magnetic field sensor, for example a Hall sensor. The prior art contains numerous teachings relevant to this concept. For example, refer to U.S. RE46428, U.S. Pat. Nos. 6,016,055, 4,110,676, US20100176803, U.S. Pat. Nos. 7,259,551, 7,259,551, WO/2018/108470, U.S. Pat. Nos. 8,087,305, 6,373,241, US20070186551, EP2071712, U.S. Pat. No. 4,547,714, DE102007018238 A1, DE102005004322 A1, U.S. Pat. Nos. 9,018,944 and 9,857,435.

In DE102007018238 A1, a need exists to move the Hall plates of an integrated sensor apart in order to locate each Hall plate closer to a North or South pole of a magnetic wheel. This application notes that Hall plates can typically not be moved far enough apart in integrated semiconductor devices due to size limitations imposed by cost. Use of a single flux-guide underneath or on top of the Hall plates to increase the magnetic field component perpendicular to a specific Hall plate is proposed, but the issue of an increase in phase angle is not addressed.

EP2259075B1 teaches the use of at least three Hall sensors to measure rotation of a magnetic wheel. Two signals are extracted after processing information obtained from the three Hall sensors, namely a speed of rotation and a direction of rotation signal. The phase angle of the direction signal relative to the speed signal may be adjusted through the use of a single flux-guide or flux-conductor, wherein the configuration, spatial positioning or orientation of the flux-guide may be changed. This patent teaches a single flux guide aligned with multiple Hall plates.

EP2259075B1 fails to present a solution for a rotation sensor that uses, for example, only two Hall plates, and where the phase angle between the distinct magnetic field signals generated by each plate need to be adjusted to allow, as one application example, rotation angle measurements.

### SUMMARY OF THE INVENTION

In an effort to clarify the disclosure of the present invention, the following summary is presented. This should not be construed as limiting to the claims of the invention, with more embodiments potentially existing than what are described in the following and which fall within the spirit and scope of the invention.

This invention specifically targets the use of Hall plates or other magnetic field sensors (further mostly referred to as Hall plates but not limited to Hall plates) for detecting and measuring rotation of a member that is coupled to a magnet.

If the Hall plates are part of a single IC the distance between the Hall plates are typically very small. If a magnet such as a disc with a single North/South polarization is the object that is rotated, with the disc in the same plane as the line drawn between the at least two Hall plates, the following problems may exist.
a. With the magnetic disc a distance away from the Hall plates, said distance being much bigger than the distance between the Hall plates, the phase angle measured between the two Hall plates may become very small.
b. The magnetic field strength reduces over distance and can become very small. This has two potential detrimental effects. If the sensor is not sensitive enough then the Signal to Noise Ratio (SNR) of the measured signal may become low, i.e. jitter and accuracy are inadequate. Or if the magnetic field sensor is sensitive enough the measurements may be affected by other magnetic fields prevalent in the sensor environment such as e.g. the earth's magnetic field.

The proposed techniques and implementations solve both problems.

Using material with a high magnetic permeability (compared with air) it is proposed to create guides (flux-guides) for the magnetic fields. This allows the capturing of magnetic fields at a preferred location within the magnetic circuit and to route (guide) these fields to the magnetic field sensors located at another point along the magnetic circuit. A magnetic circuit may be understood to, amongst others, contain elements which guide or conduct magnetic fields, as well as magnetic field sources, e.g. a magnet, and/or elements which store magnetic energy, as is known in the art.

Due to the concentrating of magnetic fields through the flux-guide the field strength may be amplified and by capturing the fields at the right locations the phase angle seen by the Hall plates on the silicon may be adjusted. A phase angle of 90 degrees may provide good discrimination and reduce jitter (improves the SNR) at certain orientations of the magnetic disc where the change in magnetic signal is relatively low.

The use of the magnetic field (flux) guides to collect and route the flux to the specific Hall plates may create many degrees of freedom for implementation. For example, the distance between the IC with the sensors and the magnet may become less of a problem and even the spatial orientation may be less restricted. Not only can the phase angle potentially be adjusted, but planar alignment may also be varied without breaking the normal algorithms used to resolve magnet orientation. The real-world spatial positioning may be adjusted using the flux-guide concept to create a pseudo, albeit more ideal, orientation between the sensors and the magnet to be measured for rotation. This may also apply to multi-axis rotation such as for a spherical magnet that can be rotated in any plane, using four Hall plates and four flux-guides. It may also be possible to improve multi-axis rotation measurements.

The flux-guides are preferably made of soft magnetic material with high permeability. The soft magnetic material refers to magnetic material that does not become permanently magnetized.

In another embodiment only one flux-guide is used to improve the phase angle and/or signal strength for single plane rotational measurements. For example, an embodiment may be possible where a single flux-guide is used to guide flux between a magnet, or another magnetic field source, and a single Hall plate to improve a measured phase angle or an amplitude of measured magnetic field strength. Due to the nature of magnetic fields, said single flux-guide may also affect the manner in which magnetic fields engage other Hall-plates or magnetic field sensors. However, for this particular embodiment said flux-guide may have the most substantial or dominant effect on the measurements of said single Hall plate.

The terms “magnetic field sensor”, “Hall plate”, and “flux sensor” are all used in this specification and are to be seen as alternatives and not restrictive.

Advantageously, embodiments of the present invention may be used to improve detection of moving parts in electronic, and other, devices. For example, a magnetic field sensor may be located in the lid of a laptop computer, wherein two flux-guides form part of the magnetic circuit and may be located close to said sensor and angled in such a manner as to increase the amount of phase shift between the signals obtained from first and second Hall plates in the sensor, with a corresponding magnet located in a base of the laptop emitting magnetic fields for generating said signals. Said magnetic circuit may comprise the magnet, the two flux-guides and the magnetic field sensor. As the lid is rotated from a closed to open position, and vice versa, said magnetic field sensor, for example a Hall sensor IC, and the two flux-guides may move in a path about the magnet in said laptop base. According to the present invention, the increase in phase angle due to use of said flux-guides may improve the accuracy with which a processor, or another circuit, may determine rotation and thereby the exact or approximate position along said path of the lid, using magnetic field strength values obtained from the first and second Hall plates. Naturally, the present invention is not limited to the use of only two Hall plates, but may use any number of Hall plates, or other magnetic field sensors, together with flux-guides to realize an increase in the phase angle or angles between signals from specific Hall plates.

In a related exemplary embodiment of the present invention, a magnetic field sensor, for example a Hall IC containing two Hall plates, may be located in a base of a laptop, as an exemplary electronic device, and an associated magnet may be located in a lid of the laptop. Magnetic flux-guides fashioned for example from ferrite or wire with a high nickel content, may again be located close to the magnetic field sensor, and may be angled to allow a substantial increase in the phase-difference between signals from a first and a second of said two Hall plates, or other sensors, to be achieved. Similar to the preceding embodiment, the magnet may move in a path about said magnetic field sensor and flux-guides as the lid is opened or closed. The present invention teaches that by the correct design and use of said flux-guides, for example two flux-guides, an increase or change in the phase angle between signals from specific Hall plates may be realized, allowing the position of the magnet along said path, and thereby the position of the laptop lid, to be determined with more accuracy and ease. This may allow the Hall IC or another circuit to discern a position of said lid between open and closed with improved accuracy.

Magnetic field sensor IC's, for example Hall-effect sensors, may make use of sensors to measure magnetic field strength in one, two or three dimensions, as is known in the art. Often, Hall plates are located in some or all of the XY, XZ and YZ planes within an IC. For a Hall-effect IC with two plates respectively located in the XY and XZ planes, as an example, the present invention teaches that for example two flux-guides may be used to increase the magnetic field strength measured by and/or the phase angle between signals from said two plates, with a first of said flux-guides oriented such that it forms a ninety-degree angle with a second of said flux-guides. The ninety-degree angle is merely provided as an example, and not as a limitation. The two flux-guides may be positioned such that magnetic fields from an associated rotating magnet are focused by one of the flux-guides onto said XY Hall plate and onto said XZ plate by the other flux-guide. It should be understood that the use of XY and XZ Hall plates is exemplary only and is not limiting. What is paramount is that the present invention teaches that the phase angle between signals from, for example, two Hall plates with dissimilar orientations can be increased or improved through the use of, for example, two flux-guides, wherein the flux-guides may be similarly or dissimilarly oriented.

In a related exemplary embodiment of the present invention, flux-guides may be used to increase or improve the phase angle between signals from Hall plates, or other magnetic field sensors, which are similarly oriented, without limiting to the manner of orientation. For example, said Hall plates may comprise two Hall plates which are both vertically oriented, in other words located in an XZ or YZ plane, or any plane in between. Or they may comprise two Hall plates which are both oriented at a specific angle to a horizontal plane, for example at forty-five degrees.

The present invention is not limited to a specific number of flux-guides used to increase or improve the phase angle between signals obtained from specific magnetic field sensors. Any number of flux-guides may be used. For example, an IC containing two Hall plates may use three flux-guides, wherein two of the guides are used to feed and return magnetic fields from and to a rotating magnet. The third flux-guide may be used to guide magnetic fields on the non-magnet side of said Hall plates, to ensure maximum SNR.

In yet another embodiment of the present invention, flux-guides may be realized on the surface of a printed circuit board (PCB). For example, techniques similar to those used to deposit carbon material on PCB's, or any other relevant technique, may be used to deposit magnetic material which may have a high relative magnetic permeability. Said magnetic material may be deposited in such a manner to tracks on the PCB, wherein the tracks may guide magnetic fields between a magnet, or another magnetic field source, and a magnetic field sensor, for example a Hall sensor. Said tracks of magnetic field may be used on their own as flux-guides, or they may be used in conjunction with other flux-guides. In other words, in an exemplary embodiment of the present invention, magnetic flux-guides used to guide magnetic fields between a magnet, or another magnetic field source, and a magnetic field sensor or sensors may partially or fully comprise said deposited magnetic material. In the case where the flux-guides partially comprise said deposited material, flux-guides fashioned from e.g. nickel wire or ferrite may be used in addition to the deposited magnetic material tracks. This may be advantageous, for example, in an application where magnetic fields are guided along the surface of the PCB, and are then guided off said surface by wire with high relative magnetic permeability towards a target situated above said PCB.

Embodiments of the present invention may be used to improve the measurement of wheel rotation in a computer mouse. Using flux-guides to increase the phase-angle measured between signals of distinct magnetic field sensors in an integrated circuit may facilitate cost-effective computer mouse wheel monitoring.

According to the present invention, it may be possible to measure or monitor rotation or movement of a magnet, or another structure, using a pair of magnetic field sensors comprising at least one horizontal magnetic field sensor and at least one vertical magnetic field sensor, wherein the magnetic field sensors may be integrated into an IC. A flux-guide or flux-guides fashioned from magnetic material with a high relative magnetic permeability may be used to increase or adjust a phase angle between signals obtained from each of the horizontal and vertical magnetic field sensors. Said increase or adjustment may be achieved by guiding magnetic fields between said magnet and said field sensors in a specific manner with said flux-guide(s). For example, a single cylindrically shaped flux-guide may be placed at a specific angle with a PCB carrying said IC and with one face of the flux-guide being in close proximity to the IC. This may cause a sufficiently large increase in said phase angle. Alternatively, or additionally, said flux-guide(s) may be used to change or improve other parameters measured by, or associated with, said field sensors. For example, the flux-guide(s) may be used to increase a concentration of magnetic field incident on the horizontal and/or vertical field sensors. The magnetic field sensors may comprise Hall plate or Hall element sensors, as is known in the art. According to the present invention, the use of a single pair of magnetic field sensors comprising a vertical and a horizontal sensor may allow a significant reduction in the size of said IC, with an associated cost reduction. Said size reduction may be possible because the vertical and horizontal sensors may be placed closer together than, e.g., two horizontal sensors for the same phase angle and/or rotation or movement measurement accuracy.

In another embodiment three or more magnetic field sensors may be used to sense the magnetic fields emanating from a magnet that rotates spatially in an orbit or track around the sensors, and the magnet orientation may be determined by selecting and using at least two sensors during a given time or period. The sensors may be selected based on the field strength and phase difference information in the sensed data generated by the sensors which may correlate to certain segments of the magnet movement or path. The magnet position may be better aligned with the selected sensors, compared with the sensors which are not selected or used. The sensors may be individually positioned or may be located on a single IC. Flux guides may be used to determine at which point in the magnetic path flux is collected to be guided between the magnet and the individual sensors.

As the movement continues from a first segment into a second segment of said magnet movement or path, a sensor associated with the first segment may fall away or be deselected and another sensor associated with the second segment, and which may have better alignment with it, may come into play and may be selected and used.

The embodiment described should allow measurement of a magnet moving up to 360 degrees around a specific sensor structure.

### BRIEF DESCRIPTION OF THE DRAWINGS

The invention is further described by way of example with reference to various embodiments depicted in the accompanying drawings and graphs:

FIG. 1 shows an IC (5) that comprises two Hall plates (6) on-chip and mounted on a printed circuit board (PCB) (4).

FIG. 2 shows a diametrically magnetized magnet with a hole in the middle position above an IC with two Hall plates, and the plane of rotation of the magnet corresponding to the line between the two Hall plates.

FIG. 3 shows an exemplary embodiment setup with two high magnetic permeability members (flux-guides) positioned above respective Hall plates.

FIGS. 4A to 4E show exemplary embodiments where a magnet is positioned above an IC with various shapes of flux-guides collecting magnetic fields at specific locations proximate to the magnet and guiding it to respective Hall plates.

FIG. 5 shows an exemplary embodiment where a diametrically magnetized rod is positioned above an IC with four Hall plates positioned on the IC.

FIG. 6 shows an exemplary construction of flux-guides positioned in relation to Hall plates on an IC that may help improve magnetic field strength and angular resolution for a diametrically magnetized rod positioned above an IC with four Hall plates positioned on the IC.

FIGS. 7A and 7B show the exemplary use of more than two flux-guides to allow a bigger magnet, better magnetic field strength at the Hall plates and to translate the magnetic fields through 90 degrees.

FIGS. 8A and 8B show the exemplary use of flux-guides in an embodiment where the rotation of a ball such as a track ball can be resolved under certain conditions.

FIGS. 9A and 9B show exemplary measurements for the same construction with and without flux-guides.

FIGS. 10A and 10B show an exemplary embodiment in a laptop computer base and lid.

FIGS. 11 A and 11B show an alternative exemplary embodiment in a laptop computer base and lid.

FIG. 12 shows an exemplary embodiment wherein flux-guides are used to guide flux to two Hall plates which are orthogonal to each other.

FIG. 13 shows the use of a third flux-guide on the non-magnet side of two Hall plates in an exemplary manner.

FIG. 14 shows an exemplary embodiment of a single flux-guide used with an integrated circuit containing a vertical and a horizontal magnetic field sensor.

### DETAILED DESCRIPTION OF EMBODIMENTS

To further clarify the disclosure of the present invention, the following descriptions relating to the appended drawings are presented. These should not be construed as limiting to the claims of the invention and are merely used to support clarity of disclosure. A large number of other equivalent embodiments may be possible that still fall within the spirit and scope of the present invention, as may be recognised by one skilled in the relevant art.

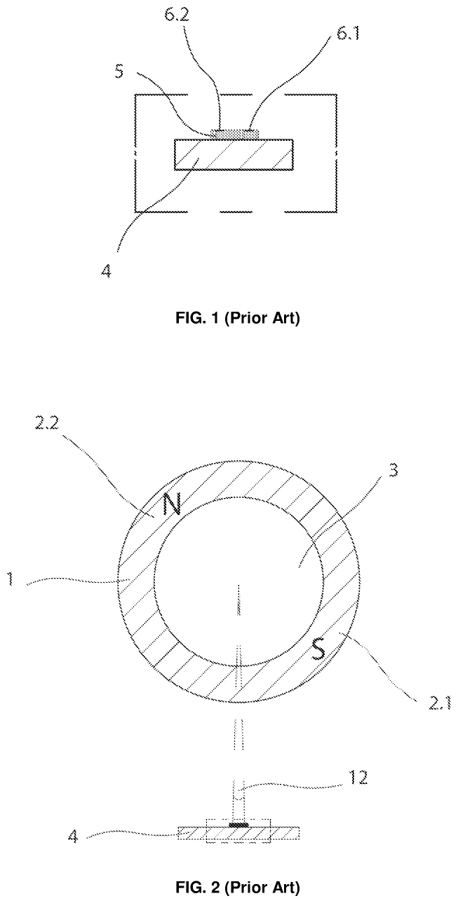

In FIG. 1 a typical prior art IC 5 is shown on a printed circuit board (PCB) 4 and the IC comprises two Hall plates 6.1 and 6.2 with a specific distance separating the two Hall plates.

In FIG. 2 that is part of what is regarded as prior art and to be improved upon is the parts of FIG. 1 mounted below a magnet 1 with a North pole 2.2 and a South pole 2.1. As can clearly be seen, the further the IC 5 is from the magnet the smaller the difference is in the field measured by the two Hall plates 6 on the IC. The phase angle 12 is a good metric for this.

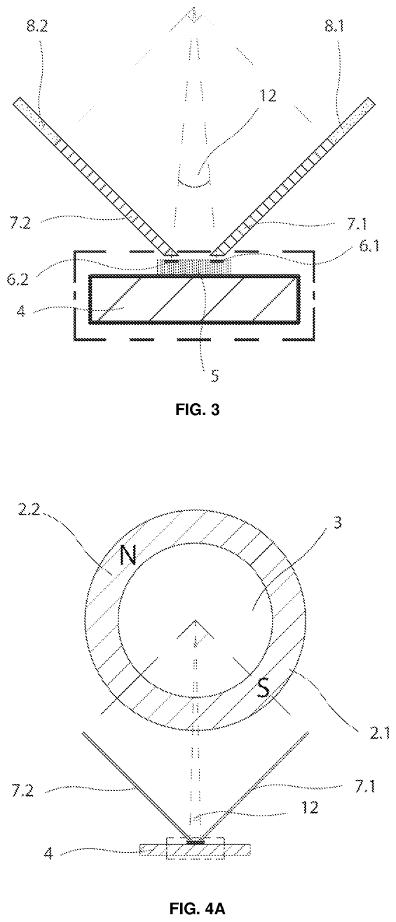

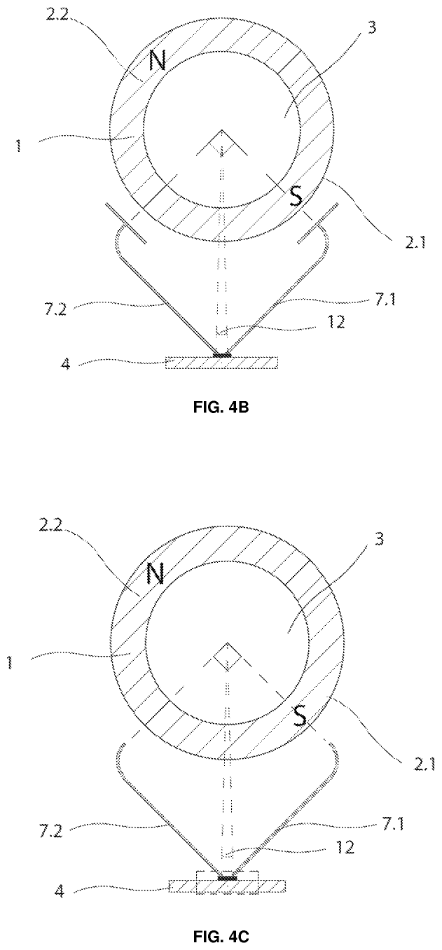

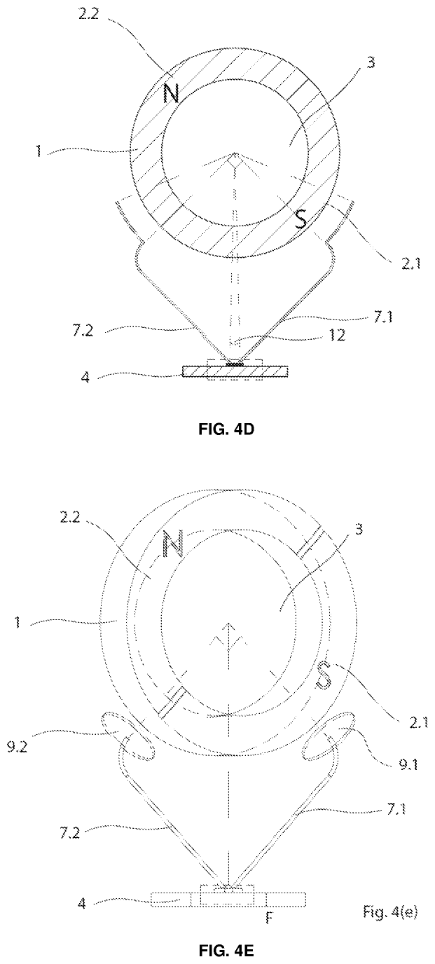

FIG. 3 shows an exemplary embodiment wherein two high magnetic permeability material members 7.1 and 7.2 are positioned respectively over the two Hall plates 6.1 and 6.2 to form flux-guides. In FIG. 4A the desired angle between the flux-guide members 7.1 and 7.2 is determined by the distance from the IC 5 to the magnet (FIG. 4 member 1), the diameter of the magnet and the desired phase difference to be measured between the two Hall plates.

The length and shape of the flux-guides can be adjusted according to the application and implementation. The length and/or shape may have an effect on the measurements. For example, if the extra length (members 8.1 and 8.2 in FIG. 3) is added to the parts 7.1 and 7.2, the signal strength and the phase angle may be affected. FIGS. 4A to 4D illustrates examples of different shapes of flux collector areas that each may have different advantages and disadvantages.

In FIG. 4E exemplary circular collector surfaces 9.1 and 9.2 are shown. The shape may also be more conical.

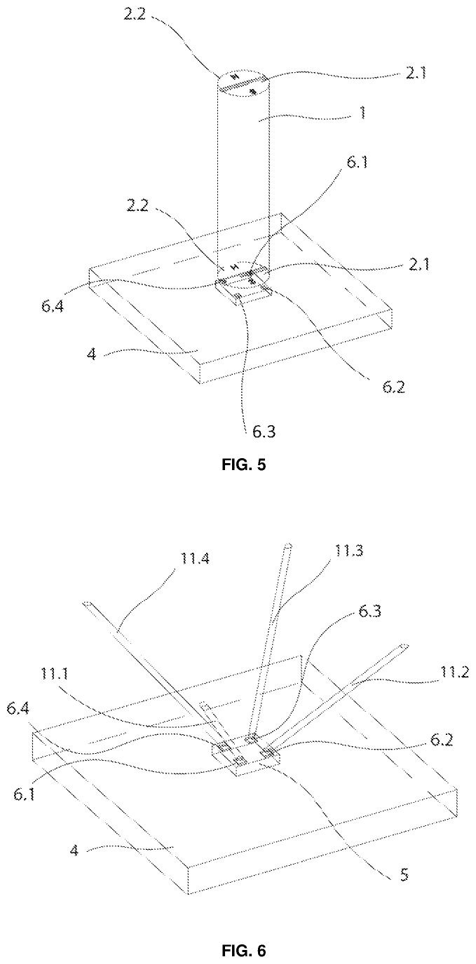

FIG. 5 shows how an exemplary magnet rod 1 is magnetized diametrically, with the end of the rod 1 positioned above an IC with multiple Hall sensors (at least two) 6.1, 6.2, 6.3 and 6.4. As is evident from FIG. 5, one end face of said rod may face an upper face of said IC. An advantage of four sensors is that a wobble in the rod rotation can potentially be negated mathematically using all of the sensors' measurement information. Such a wobble in the rod rotation measurements may be caused by a rod which is not perfectly straight, as one example. Or it may be caused by misalignment between an axis of said rod and a centre point between said four sensors. Being able to mathematically, that is by digital processing, remove wobbling from the rod rotation measurements may greatly ease manufacturing tolerances and constraints.

In FIG. 6 flux-guides 11.1, 11.2, 11.3 and 11.4 are positioned in an exemplary manner above the various sensor plates 6.1 to 6.4.

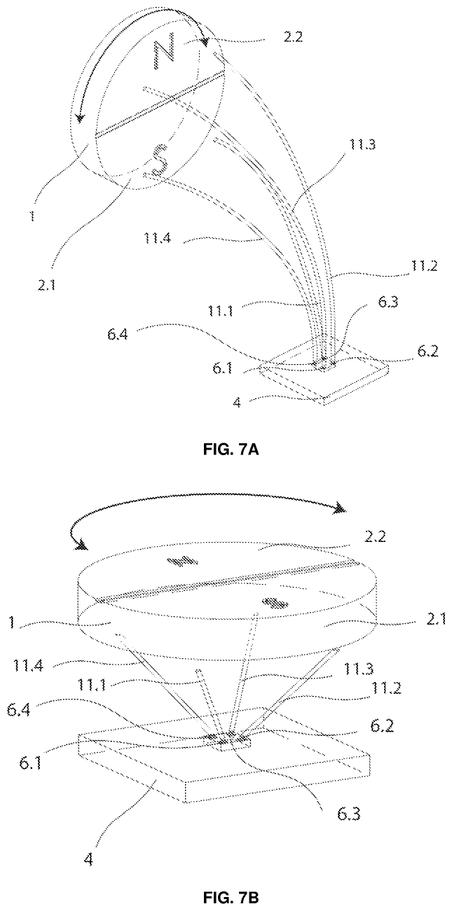

In FIG. 7A flux-guides 11.1 to 11.4 may help to improve magnetic field signal strength when the magnet is far away from the Hall plates and also to handle bigger magnets which may be positioned to rotate around an axis.

In FIG. 7B the magnet rotation is translated through ninety-degrees by the flux-guides 11.1 to 11.4 and this may allow for the IC containing Hall sensors 6.1, 6.2, 6.3 and 6.4 to be positioned on a PCB 4 that is parallel to the plane of the magnet rotation. In the configurations shown in FIG. 7B the Hall plates may measure flux in the Z-axis direction, with PCB 4 lying in the XY-plane.

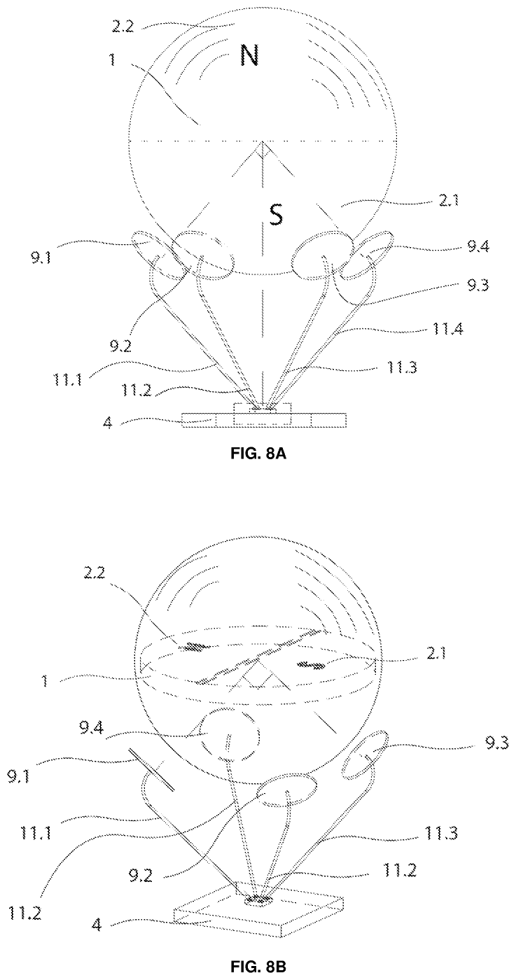

The exemplary embodiment shown in FIG. 8A may be used to measure a spherical magnet 1 that is rotated in any direction. The position can typically not be resolved when the North-South axis is parallel to the IC. The North-South axis is defined as an axis which cuts through the centre of the North pole and the South pole, similar to that conventionally used in the art. So, if the S pole is at the bottom when starting, as depicted in FIG. 8A, the rotation may be accurately measured and the orientation uniquely resolved as long as the S pole does not rotate 90 degrees to the top. In the embodiment shown by FIG. 8A, circular flux collector plates 9.1 to 9.4 may be used to collect magnetic flux from said magnet.

In FIG. 8B a disc magnet is used that can be positioned inside a sphere to allow more rotations to be resolved.

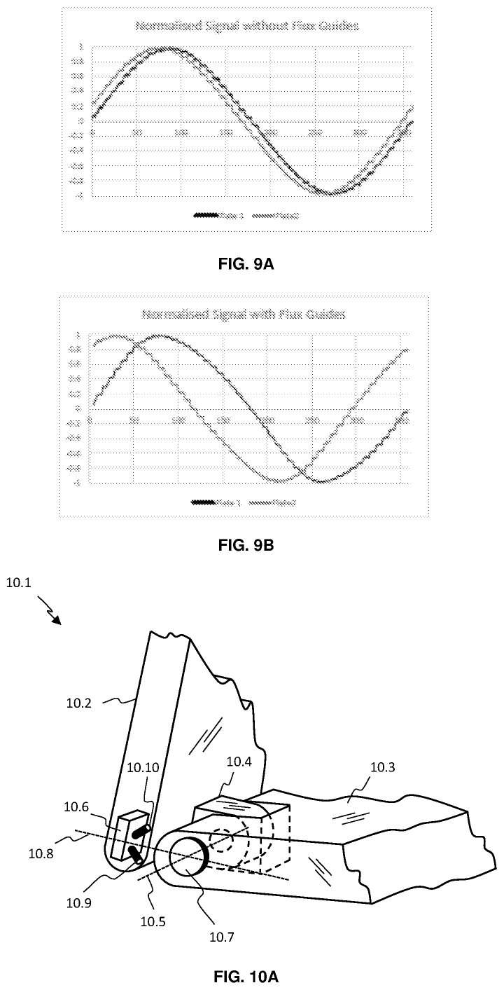

The results are excellent as can be seen in the difference in the phase angles of FIGS. 9A and 9B. FIG. 9A shows measurements from a setup shown in FIG. 2, whilst 9B shows measurements from FIG. 4A. The real-world measurements from the two Hall plates are shown with the magnet rotated through 360 degrees. In FIG. 9A using a 10 mm diameter ring magnet, 15 mm away from the IC (centre of magnet) with no flux-guides, the phase difference between the two plates was measured at approximately 8 degrees. In FIG. 9B the signals measured in an embodiment using the same setup but with flux-guides, according to FIG. 4A, show a phase angle difference of approximately 60 degrees.

Please note the flat sections in the FIG. 9 signals are the result of the stepper motor steps.

This better phase angle of FIG. 9B translates into a much improved SNR resulting in improvements in e.g., jitter and linearity error. In this practical setup using an Azoteq ProxFusion™ IC this gives an improvement from ±15 degrees accuracy to a ±1 degree accuracy by only adding the flux-guides.

The flux-guides can be made with ferromagnetic metal such as iron rods or ferromagnetic material/compounds such as ferrite, all with high magnetic permeability compared to the surrounding air. The present invention is not limited only to these materials for the construction of flux-guides, but may use any suitable magnetic material which has a sufficiently high relative magnetic permeability. In addition, the teachings of the present invention may also be practised with flux-guides which differ in configuration, number and structure from those depicted in exemplary manner in the appended drawings or described herein.

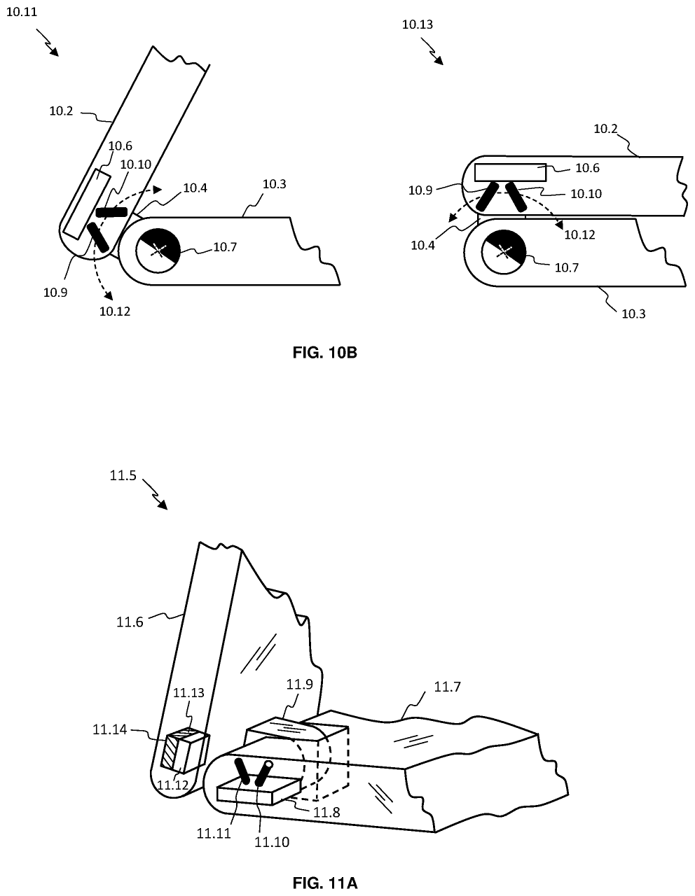

FIGS. 10A and B depict an exemplary embodiment of the present invention in a laptop computer. It should be appreciated that a laptop is merely used as an example of an electronic device, and does not limit the present invention. As shown at 10.1, a laptop base 10.3 and lid 10.2 may move relative to each other, with a hinge 10.4 which may facilitate rotation of the lid 10.2 about an axis 10.5. A disk magnet 10.7, for example a diametrically polarized magnet with one North pole and one South pole, may be located in said base 10.3 as shown. A magnetic field sensor 10.6, for example a Hall-effect sensor, may be located in the lid 10.2, and may have two Hall plates used to measure the magnetic field strength and direction of magnet 10.7. According to the present invention, a first flux-guide 10.9 and a second flux-guide 10.10 may also be positioned in the lid 10.2 as shown in order to increase or improve the phase angle between the signals from the respective Hall plates of sensor 10.6. Although flux-guides 10.9 and 10.10 are drawn at an angle to each other, and with a certain shape and qualitative length, this is merely exemplary, and the present invention should not be limited in this regard. For example, the two flux-guides may be oriented parallel to each other, or at an angle of hundred-and-eighty degrees. They may be significantly shorter or longer, or one may be short and one long, relatively speaking. They may also be fashioned in any form or format and/or orientation needed to increase or improve said phase angle.

Cross-sectional views along line 10.8 for the laptop lid in an open and closed position is shown at 10.11 and 10.13 respectively in FIG. 10B. As depicted, the two flux-guides 10.9 and 10.10 may follow a path 10.12 about the static magnet 10.7 located in laptop base 10.3.

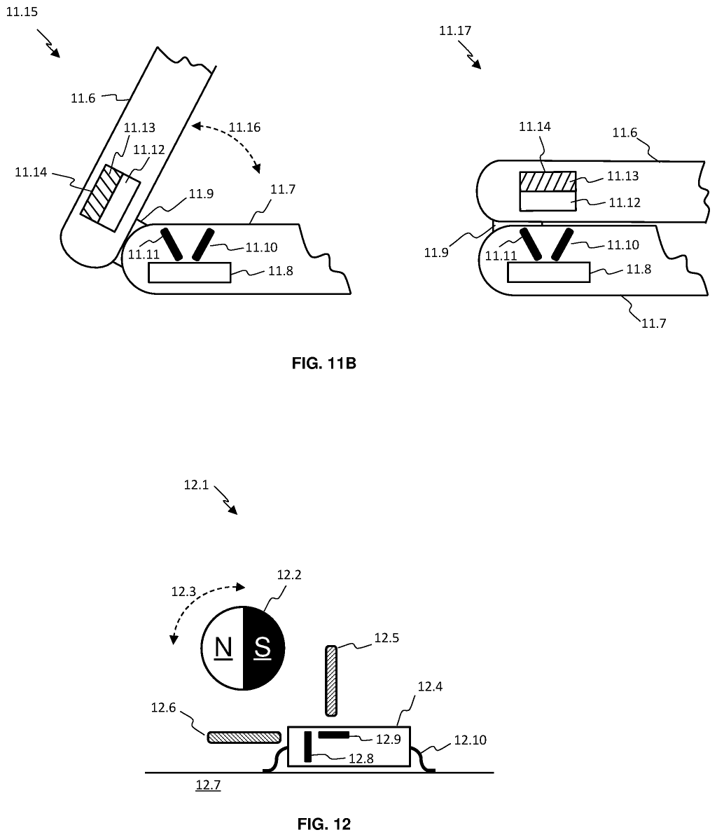

FIGS. 11A and B show an exemplary embodiment related to that of FIG. 10, but wherein the locations of the magnet and magnetic field sensor are interchanged. A bar magnet 11.14 with magnetic poles 11.12 and 11.13 may be located in lid 11.6 of a laptop, as an exemplary electronic device. The invention need not be limited to the use of bar magnets, or to that depicted. The lid 11.6 may rotate towards or away from the base 11.7 using a hinge 11.9. A magnetic sensor, for example a two plate Hall sensor, 11.8 may be located in the base 11.7 as depicted. According to the present invention two flux-guides 11.10 and 11.11 may be used to guide flux from the magnet 11.14 in such a manner as to increase or improve the phase angle between signals from respective Hall plates in the sensor 11.8, and/or to improve the measurement of magnetic field strength and direction by said plates in another manner.

An open and closed lid are shown in cross-sectional views at 11.15 and 11.17 in FIG. 11B respectively. The lid 11.6 may move along a path 11.16 towards and from the base 11.7, as depicted. In light of the foregoing, FIG. 11B is fairly self-explanatory and will not be elaborated on further.

According to the present invention, flux-guides may also be used with magnetic sensors which are orthogonal to each other within an IC. An exemplary embodiment is shown in a cross-sectional view at 12.1 in FIG. 12, wherein a magnetic sensor IC 12.4, for example a Hall-effect IC, is located on a substrate 12.7, with electrical connections provided via legs or contacts 12.10, as is known in the art. First and second Hall plates 12.8 and 12.9 respectively may be located within IC 12.4, and may be orthogonal to each other, as shown. For example, the plate 12.8 may be located within an XZ-plane and the plate 12.9 may be located within an XY-plane. Flux-guides 12.5 and 12.6 may be used to guide magnetic fields between a magnet 12.2 and said plates, with the magnet 12.2 rotating in either of the directions depicted by 12.3. The present invention teaches that correct location, orientation, geometry and material choice for said flux-guides 12.5 and 12.6 may be used to improve measurement of the magnetic fields of the magnet 12.2. For example, flux-guides 12.5 and 12.6 may be used to increase or change the phase angle between signals from the Hall plates 12.8 and 12.9, thereby facilitating greater ease and/or accuracy of rotation measurement.

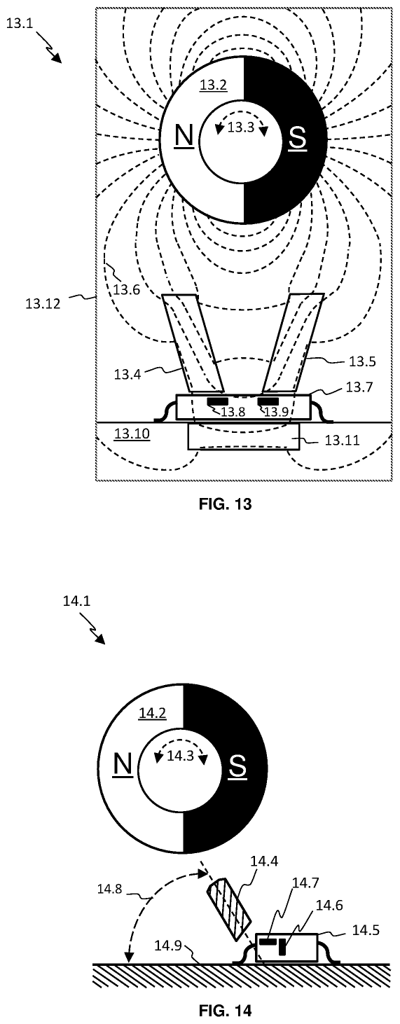

Yet another exemplary embodiment of the present invention is shown at 13.1 in FIG. 13. An IC 13.7 is located on a substrate 13.10 below a magnet 13.2 that rotates in a direction 13.3. The IC may be a magnetic field sensor, for example a Hall-effect IC, and may comprise first and second Hall plates 13.8 and 13.9, Two flux-guides 13.4 and 13.5 may be located above and in close proximity to the IC 13.7, and may guide magnetic fields between the magnet 13.2 and the Hall plates 13.8 and 13.9. The Figure depicts magnetic field lines 13.6 in an exemplary manner, bounded by a box 13.12 for clarity, illustrating said guiding to some extent. According to the present invention, the flux-guides may be used to increase or change the phase angle between the two signals respectively obtained from the Hall plates 13.8 and 13.9. The flux-guides may be used to change the concentration or level of magnetic fields incident on said Hall plates, leading to an increase in the amplitude of signals obtained from said Hall plates. In addition, the present invention teaches that another flux-guide 13.11 may be used on the non-magnet side of the sensor IC 13.7, as shown. This may further reduce the reluctance of the magnetic field path in the magnetic circuit, leading to an increase in field strength measured. It may also increase or change the concentration of magnetic field incident on a particular plate on sensor, and may also be used to affect changes to the phase angle between signals from respective Hall plates or sensors.

It may also be possible to improve rotation measurement accuracy and cost-effectiveness using a single flux-guide together with an IC containing at least one vertical and at least one horizontal magnetic field sensor. Such an embodiment is depicted in an exemplary manner at 14.1 in FIG. 14. A magnet 14.2, for example a disk magnet or a diametrically magnetized ring magnet, may be located above an IC 14.5, with the latter supported by and located on a PCB 14.9. The magnet 14.2 may rotate in either of the directions shown by the arrows 14.3. IC 14.5 may contain a vertical magnetic field sensor 14.6, for example a vertical Hall sensor or Hall plate, and a horizontal magnetic field sensor 14.7, for example a horizontal Hall sensor or Hall plate. A magnetic flux-guide or flux-conductor 14.4 may be situated between the magnet 14.2 and the IC 14.5, with one end or face of the flux-guide in close proximity to the IC, as depicted. The flux-guide 14.4 may be oriented at an angle 14.8 with the PCB 14.9. According to the present invention, a phase-angle between signals from the vertical and horizontal magnetic field sensors may be increased or improved by the use of the flux-guide 14.4, which may facilitate improved rotation measurement of the magnet 14.2, or of a structure or device attached to said magnet. For example, by setting the flux-guide 14.4 at a specific angle 14.8 for a certain set of parameters, which may include flux-guide material properties and dimensions, magnet field strength, distance between the magnet and IC, flux-guide location and sensor parameters, amongst others, it may be possible to significantly increase said phase-angle and improve rotation measurement. Alternatively, or additionally, other parameters measured by, or associated with, the vertical and horizontal magnetic field sensors may be changed, adjusted or improved through the use of the flux-guide 14.4.

An exemplary embodiment as depicted in FIG. 14 may enable a cost-reduction by allowing a smaller IC to be used for rotation measurements than what would be the case for two horizontal magnetic field sensors, given the typical minimum distance required between horizontal sensors.

Herein, “or” is used to convey inclusive and not exclusive, unless expressly indicated otherwise or indicated otherwise by context. Therefore, herein, “A or B” may mean “A, B, or both,” unless expressly indicated otherwise or indicated otherwise by context. In addition, “and” is used to convey both joint and several, unless expressly indicated otherwise or indicated otherwise by context. Therefore, “A and B” may mean “A and B, jointly or severally,” unless expressly indicated otherwise or indicated otherwise by context.

1. A combination of an electronic circuit and a magnetic circuit for measuring movement between a magnet and an integrated circuit, wherein the combination comprises the integrated circuit with at least two on-chip magnetic field sensors, the magnet and at least one flux-guide(s) that guide magnetic flux between the magnet and at least one of the magnetic field sensors, wherein the magnet is positioned a distance away from said integrated circuit, and wherein use of the flux guide(s) increases a phase angle present between the magnetic field strength signals generated by each of said on-chip sensors.

2. The combination of claim 1, with said flux-guide(s) being at least equal in number to the number of on-chip magnetic field sensors with each flux-guide aligned with a respective one of said on-chip magnetic field sensors.

3. The combination of claim 1, wherein the movement measured is due to rotational movement of said magnet.

4. The combination of claim 1, wherein the movement measured is the result of spatial movement of the integrated circuit around said magnet.

5. The combination of claim 1, wherein the flux-guide(s) increase the magnetic field strength measured by the magnetic field sensors.

6. The combination of claim 1, where the magnetic field sensors are Hall plates.

7. The combination of claim 1, wherein said magnet is located in a base of a laptop computer and said integrated circuit is located in a lid of the laptop computer, and wherein said measured movement comprises rotation of said integrated circuit about said magnet, with said rotation used to discern a lid position between open and closed.

8. The combination of claim 1, wherein said magnet is located in a lid of a laptop computer and said integrated circuit is located in a base of the laptop computer, and wherein said measured movement comprises rotation of said magnet about said integrated circuit, with said rotation used to discern a lid position between open and closed.

9. The combination of claim 1, wherein said flux-guide(s) cause magnetic fields between the magnet and integrated circuit to transition from a first plane to a second plane, wherein the first plane is orthogonal to said second plane.

10. The combination of claim 1, wherein an additional flux-guide is located on the non-magnet side of said integrated circuit.

11. The combination of claim 1, wherein said flux-guide(s) partially or fully comprises magnetic material with high relative magnetic permeability deposited onto a printed circuit board to form tracks of magnetic material for guiding or routing magnetic flux between its origin and said magnetic field sensors.

12. The combination of claim 1, comprising at least three magnetic field sensors to determine the orientation of the magnet, wherein said magnet is movable in a spatial orbit or track around the sensors, wherein at least two sensors are selected and used per segment of said orbit or track and wherein flux-guides are used to guide magnetic flux between the magnet and the sensors.

13. A method for measuring movement between a magnet and an integrated circuit, wherein the integrated circuit comprises at least two on-chip magnetic field sensors and said magnet is positioned a distance away from the integrated circuit, and wherein the method comprises the steps of using at least one flux-guide(s) to guide magnetic flux between said magnet and at least one of said sensors in such a manner as to increase a phase angle present between magnetic field strength signals generated by each of said on-chip sensors, and of using the increase in phase angle(s) during movement measurement.

14. The method of claim 13, wherein the flux-guide(s) are at least equal in number to the number of on-chip magnetic field sensors, and comprising the additional step of aligning each flux-guide with a respective one of said on-chip magnetic field sensors.

15. The method of claim 13, wherein the movement measured is due to rotational movement of said magnet.

16. The method of claim 13, wherein the movement measured is the result of spatial movement of the integrated circuit around said magnet.

17. The method of claim 13, wherein the flux-guide(s) increase the magnetic field strength measured by the magnetic field sensors.

18. The method of claim 13, wherein said magnet is located in a base of a laptop computer and said integrated circuit is located in a lid of the laptop computer, and wherein the measured movement is due to rotation of said integrated circuit about said magnet, and wherein the method comprises the additional step of using the measured movement to discern a lid position between open and closed.

19. The method of claim 13, wherein said magnet is located in a lid of a laptop computer and said integrated circuit is located in a base of the laptop computer, and wherein the measured movement is due to rotation of said magnet about said integrated circuit, and wherein the method comprises the additional step of using the measured movement to discern a lid position between open and closed.

20. The method of claim 13, wherein each of said flux-guide(s) partially or fully comprises magnetic material with high relative magnetic permeability deposited onto a printed circuit board to form tracks of magnetic material for guiding or routing magnetic flux between its origin and said magnetic field sensors.
